(19) United States
(12) Patent Application Publication
(10) Pub. No.: US 2011/0270746 A1
(43) Pub. Date: Nov. 3, 2011

(54) ELECTRONIC MONEY PAYMENT SYSTEM AND ELECTRONIC MONEY PAYMENT METHOD

(75) Inventor: Jong Ho Kim, Gyeonggi-do (KR)

(73) Assignee: SK TELECOM CO., LTD., Seoul (KR)

(21) Appl. No.: 13/144,913

(22) PCT Filed: May 18, 2010
(86) PCT No.: PCT/KR2010/003127

§ 371 Date: Jul. 15, 2011

(30) Foreign Application Priority Data
Jun. 9, 2009 (KR) 10-2009-0050956

(51) Int. Cl. G06Q 40/00; G06Q 20/00

(52) U.S. Cl. 705/39

(57) ABSTRACT

The present disclosure relates to electronic money payment system and method which allows payment to be processed not only with a payment amount according to the currency of a user's electronic money but also with a payment amount according to any currency advantageous for payment among various payment amounts according to various types of currencies which are different from that of the user's electronic money, in consideration of the exchange rates.

### TECHNICAL FIELD

The present invention relates to an electronic money payment system, and more particularly to an electronic money payment system and method, a terminal for electronic money payment and a payment method by the terminal, and an electronic money service center and a payment method by the electronic money service center, wherein when an electronic money payment request is made, payment can be processed not only with a payment amount according to the currency of a user's electronic money but also with a payment amount according to any currency advantageous for payment among various payment amounts according to various types of currencies which are different from that of the user's electronic money, in consideration of the exchange rates.

### BACKGROUND ART

An electronic money is a virtual money having a predetermined monetary value provided by an electronic money issuer in return for paying a corresponding cost to the issuer, wherein such an electronic money is advantageous in that the risks of counterfeiting or falsifying the electronic money are relatively low, no loss will be caused even if the electronic money is stolen or lost, and the electronic money is convenient for micro-payment.

However, despite of the advantages described above, electronic moneys are not relatively vitalized as compared to credit cards since the electronic moneys lack interchangeability in use.

Since electronic money issuers adopt different payment systems on the basis of different IC chips, respectively, an electronic money can be used only in an electronic money payment terminal suitable for the type of the currency of the electronic money, and there is inconvenience in a user's position in that the user should prepare an electronic money of each electronic money issuer.

In particular, when a user purchases one or more goods in a place, such as a duty-free shop that deals in various goods priced by various types of electronic moneys, there is a problem in that it is difficult for the user to obtain monetary profit according to exchange rates even in a case in which it may be more inexpensive in terms of cost in view of current exchange rates not to pay in the electronic money owned by the user (KR won) but to pay in any of other types of electronic moneys (US dollars, JP yen, etc.) which are different from the electronic money owned by the user in terms of currency.

### DISCLOSURE

### Technical Problem

It is an object of the present invention to provide an electronic money payment system and method, wherein when a terminal receives a predetermined electronic money payment request and makes a request for payment amount information of each currency in accordance with the payment request amount according to the electronic money payment request, an electronic money service center receives the payment amount information of each currency in accordance with the payment request amount from the terminal and provides the terminal with the payment amount information of each currency, which is obtained through exchanging of the payment request amount based on exchange rate information of each currency, and when a request for processing payment for the payment amount in a predetermined currency among the payment amount information of each currency, the electronic money service center processes payment in accordance with the payment amount of the predetermined currency, whereby when an electronic money payment request is made, payment can be processed not only with a payment amount according to the currency of the user's electronic money but also with a payment amount according to any currency advantageous for payment among various payment amounts according to various types of currencies which are different from that of the user's electronic money, in consideration of the exchange rates.

Another object of the present invention is to provide a terminal for electronic money payment and a payment method by the terminal, wherein if a predetermined electronic money payment request is input, the terminal sends a request for payment amount information of each currency in accordance with the payment request amount according to the electronic money payment request to an external electronic money service center, and shows the payment amount information of each currency received from the electronic money service center to be capable of being recognized by a user, and sends a request for processing payment in accordance with the payment amount in a predetermined currency selected from the payment amount information of each currency to the electronic money service center, whereby when an electronic money payment request is made, payment can be processed not only with a payment amount according to the currency of the user's electronic money but also with a payment amount according to any currency advantageous for payment among various payment amounts according to various types of currencies which are different from that of the user's electronic money, in consideration of the exchange rates.

Another object of the present invention is to provide an electronic money service center and a payment method by the electronic money service center, wherein exchange rate information of each currency are stored in the electronic money service center, and when receiving a request for payment amount information of each currency according to a payment request amount from an external terminal, the electronic money service center conducts foreign exchange, calculates a payment amount of each currency based on the exchange rate information of each currency in accordance with the payment request amount, and provides the terminal with the calculated payment amount information of each currency, whereby when an electronic money payment request is made, payment can be processed not only with a payment amount according to the currency of the user's electronic money but also with a payment amount according to any currency advantageous for payment among various payment amounts according to various types of currencies which are different from that of the user's electronic money, in consideration of the exchange rates.

### Technical Solution

In accordance with an aspect of the present invention, there is provided an electronic money payment system including: a terminal for making a request for payment amount information of each currency in accordance with a payment request amount according to an electronic money payment request when the electronic money payment request is input to the terminal; and an electronic money service center for, when receiving the request for payment amount information of each currency, providing the terminal with the payment amount information of each currency, which is obtained through exchanging of the payment request amount based on exchange rate information of each currency, and for, when receiving the request for processing payment of a payment amount of a predetermined currency from the terminal, processing payment of the payment amount of the predetermined currency.

According to an embodiment of the present invention, when receiving the payment amount information of each currency from the electronic money service center, the terminal may display the payment amount information of each currency and send a request for processing payment in accordance with the payment amount of a predetermined currency selected from the payment amount information of each currency to the electronic money payment system.

In accordance with another aspect of the present invention, there is provided a terminal including: a manipulation unit for receiving a user's input; and a terminal control unit for sending a request for payment amount information of each currency to an external electronic money service center in accordance with a payment request amount according to an electronic money payment request when the electronic money payment request is input through the manipulation unit, displaying the payment amount information of each currency received from the electronic money service center in response to the request for payment amount information of each currency, and sending a request for processing payment in accordance with a payment amount of a predetermined currency selected from the payment amount information of each currency through the manipulation unit to the electronic money payment system.

According to an embodiment of the present invention, the terminal may further include a card interface unit for communicating with an approaching electronic money card, wherein the terminal control unit recognizes the approaching electronic money card through the card interface unit, and when an electronic money payment request is input through the manipulation unit, the terminal control unit may send a request for payment amount information of each currency in accordance with a payment request amount according to the electronic money payment request to the electronic money service center.

In addition, according to an embodiment of the present invention, the terminal control unit may send a request for processing payment for the electronic money card in accordance with the payment amount of the currency selected through the manipulation unit to the electronic money service center, and when receiving an electronic money deduction signal from the electronic money service center in response to the request for processing payment for the electronic money card, the terminal control unit may deduct the electronic money of the electronic money card in accordance with the electronic money deduction signal.

In addition, according to an embodiment of the present invention, the terminal may further include an electronic money card for storing electronic money, wherein the terminal control unit sends a request for processing payment for the electronic money card in accordance with the payment amount of the currency selected through the manipulation unit to the electronic money service center, and when receiving an electronic money deduction signal from the electronic money service center in response to the request for processing payment for the electronic money card, the terminal control unit deducts the electronic money of the electronic money card in accordance with the electronic money deduction signal.

In accordance with another aspect of the present invention, there is provided an electronic money service center including: an exchange rate memory unit for storing exchange rate information of each currency; a payment amount calculation unit for conducting foreign exchange in accordance with a payment request amount, and calculating a payment amount of each currency based on the exchange rate information of each currency; and a service providing unit for, when receiving a request for payment amount information of each currency according to a payment request amount from an external terminal, sending the request for payment amount information of each currency, which is obtained through exchanging of the payment request amount, to the payment amount calculation unit, and providing the terminal with the payment amount information of each currency calculated by the payment amount calculation unit.

According to an embodiment of the present invention, when receiving a request for processing payment of an electronic money card for the payment amount of the predetermined currency selected among the payment amount information of each currency from the terminal after the electronic money service center provides the terminal with the payment amount information of each currency, the service providing unit may process payment in accordance with the payment amount of the predetermined currency when it is possible to process payment of the electronic money card.

According to an embodiment of the present invention, when processing the payment in accordance with the payment amount of the predetermined currency, the service providing unit may provide the terminal with an electronic money deduction signal according to the payment amount of the predetermined currency as being payment-processed.

In accordance with another aspect of the present invention, there is provided an electronic money payment method including the steps of: making, by a terminal, a request for payment amount information of each currency in accordance with a payment request amount according to an electronic money payment request that is input to the terminal; providing, by an electronic money service center, the terminal with payment amount information of each currency, which obtained through exchanging of the payment request amount based on exchange rate information of each currency, if the request for payment amount information of each currency is received from the terminal in accordance with the payment request amount; and processing payment, by the electronic money service center, in accordance with the payment amount of a predetermined currency if a request for processing payment for the payment amount of a predetermined currency among the payment amount information of each currency is made by the terminal.

According to an embodiment of the present invention, the electronic money payment method may further include the steps of: displaying, by the terminal, the payment amount information of each currency when the payment amount information of each currency is received from the electronic money service center; and requesting, by the terminal, the electronic money service center to process payment in accordance with the payment amount of the predetermined currency selected among the payment amount information of each currency.

In accordance with another aspect of the present invention, there is provided a payment method by a terminal including the steps of: determining whether an electronic money payment request is input or not; sending a request for payment amount information of each currency in accordance with a payment request amount according to the electronic money payment request to an external electronic money service center if the electronic money payment request is input; displaying the payment amount information of each currency received from the electronic money service center; and sending a request for processing payment in accordance with the payment amount of a predetermined currency selected among the payment amount information of each currency to the electronic money service center.

According to an embodiment of the present invention, the step of determining whether the electronic money payment request is input or not may include the steps of: recognizing an approaching electronic card; and determining whether the electronic money payment request is input in accordance with the recognized electronic money card.

In addition, according to an embodiment of the present invention, the payment method by a terminal may further include the step of: deducting the electronic money of the electronic money card in accordance with an electronic money deduction signal if the electronic money deduction signal is received from the electronic money service center in response to the request sent to the electronic money service center for processing payment for the electronic money card in accordance with the payment amount of the selected currency.

According to an embodiment of the present invention, the payment method by a terminal may further include the step of: deducting the electronic money of the electronic money card in accordance with an electronic money deduction signal if the electronic money deduction signal is received from the electronic money service center in response to the request sent to the electronic money service center for processing payment for the electronic money card incorporated in the terminal in accordance with the payment amount of the selected currency.

In accordance with another aspect of the present invention, there is provided a payment method by an electronic money service center including the steps of: storing exchange rate information of each currency; conducting foreign exchange based on the exchange rate information of each currency, and calculating payment amount of each currency in accordance with a payment request amount if a request for payment amount information of each currency according to the payment request amount is received from an external terminal; and providing the terminal with the calculated payment amount information of each currency.

According to an embodiment of the present invention, the payment method by an electronic money service center may further include the steps of: determining whether a request for processing payment of an electronic money card for the payment amount of a predetermined currency among the payment amount information of each currency is received from the terminal after the payment amount information of each currency is provided to the terminal; and processing payment in accordance with the payment amount of the predetermined currency if the request for processing payment is received and if it is possible to process payment of the electronic money card.

According to an embodiment of the present invention, the payment method by an electronic money service center may further include the step of: providing the terminal with an electronic money deducting signal according to the processed payment amount in the predetermined currency if payment is processed in accordance with the payment amount of the predetermined currency.

### Advantageous Effects

According to the inventive electronic money payment system and method, when a user makes a request for electronic money payment for a predetermined payment request amount through a terminal, the terminal shows payment amount information of each currency according to the payment request amount through the cooperation between the terminal and an electronic money service center to the user, so that the user can select a payment amount according to a monetarily advantageous currency, and can process payment with the payment amount according to the selected currency.

In addition, according to the inventive electronic money payment system and method, when a payment request using electronic money is made, it is possible to process payment not only with a payment amount according to the currency of the user's electronic money but also with a payment amount according to any currency advantageous for payment among various payment amounts according to various types of currencies which are different from that of the user's electronic money, in consideration of the exchange rates: as a result, since the user can process payment with a payment amount of a currency, which is different from that of the user's electronic money, using the user's own electronic money, the user can obtain monetary profit according to current exchange rates.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a control block diagram of an electronic money payment system in accordance with an embodiment of the present invention;

FIG. 2 a control block diagram of a terminal in accordance with an embodiment of the present invention;

FIG. 3 is a control block diagram of a terminal in accordance with another embodiment of the present invention;

FIG. 4 is a control block diagram of an electronic money service center in accordance with an embodiment of the present invention;

FIG. 5 is a flowchart showing a control flow of an electronic money payment method in accordance with an embodiment of the present invention;

FIG. 6 is a flowchart showing a control flow of a payment method of a terminal in accordance with an embodiment of the present invention; and

FIG. 7 is a flowchart showing a control flow of a payment method of an electronic money service center in accordance with an embodiment of the present invention.

### BEST MODE

### Mode for Invention

Hereinafter, exemplary embodiments of the present invention will be described with reference to the accompanying drawings. However, the present invention is not restricted or limited. In addition, the same reference numerals indicated in the accompanying drawings indicate the same components, respectively.

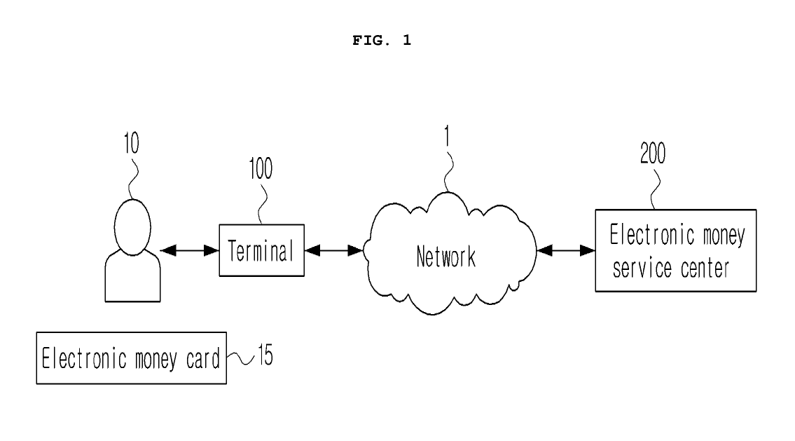

FIG. 1 shows an electronic money payment system in accordance with an embodiment of the present invention.

As shown in FIG. 1, the inventive electronic money payment system includes: a terminal 100 for sending a request for payment amount information of each currency in accordance with a payment request amount in according to an electronic money payment request when the electronic money payment request is input to the terminal 100; and an electronic money service center 200 for, when receiving a request for payment amount information of each currency from the terminal, providing the terminal 100 with the payment amount information of each currency, which is obtained through exchanging of the payment request amount based on exchange rate information of each currency, and for, when receiving a request for processing payment for a payment amount of a predetermined currency from the terminal 100, processing payment in accordance with the payment amount of the predetermined currency.

The network shown in FIG. 1 is an interworking network which supports the terminal 100 and the electronic money service center 200 in such a manner that they can communicate with each other, and may include various communication networks, such as a wired/wireless communication network, a wired/wireless Internet network, a portable Internet network (e.g., a wireless broadband network), a mobile communication network, a wired communication network, a banking network or the like.

When an electronic money payment request is input by a user 10 to request a payment using electronic money, the terminal 100 accesses the electronic money service center 200 through the network 1 and sends a request for payment amount information of each currency in accordance with the payment request amount according to the electronic money payment request to the electronic money service center 200.

Here, the terminal is a payment device positioned at a store, such as a duty-free shop, a bookstore or the like, wherein the terminal 100 takes a form adapted to recognize an electronic money card 15 presented by the user 10 who makes a request for processing payment using electronic money, so that when a predetermined electronic money payment request is input by the user 10, the terminal 100 can send a request for payment amount information of each currency in accordance with a payment request amount according to the electronic money payment request to the electronic money service center 200. At this time, the electronic money card 15 may be a plastic card that stores electronic money, like a coin card, a T-money card or the like.

Meanwhile, the terminal 100 is a mobile device, such as a notebook computer, a PDA, or a mobile communication terminal, held by the user 10, wherein the terminal 100 may take a form adapted to incorporate an electronic money card therein, so that when a predetermined electronic money payment request is input by the user 10, the terminal 100 can send a request for payment amount information of each currency in accordance with a payment request amount according to the electronic money payment request to the electronic money service center 200. At this time, the electronic money card incorporated in the terminal 100 may be a user identification card of a smart card type, such as a SIM (Subscriber Identification Module) card or a USIM (Universal Subscriber Identification Module) card.

When receiving the payment amount information of each currency in response to the request for payment amount information of each currency in accordance with the payment request amount sent to the electronic money service center 200, the terminal 100 shows the payment amount information of each currency to be capable of being recognized by the user 10, and sends a request for processing payment in accordance with the payment request amount of a predetermined currency selected from the payment amount information of each currency to the electronic money service center 200.

When receiving the request for payment amount information of each currency in accordance with the payment request amount from the terminal 100, the electronic currency service center 200 provides the terminal 100 with the payment amount information of each currency, which is obtained through exchanging of the payment request amount based on exchange rate information of each currency.

In addition, when receiving a request for processing payment in accordance with the payment amount of a predetermined currency from the terminal 100, the electronic money service center 200 processes payment in accordance with the payment amount of the predetermined currency.

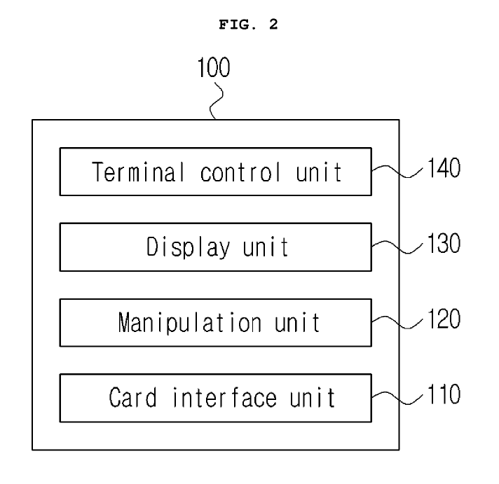

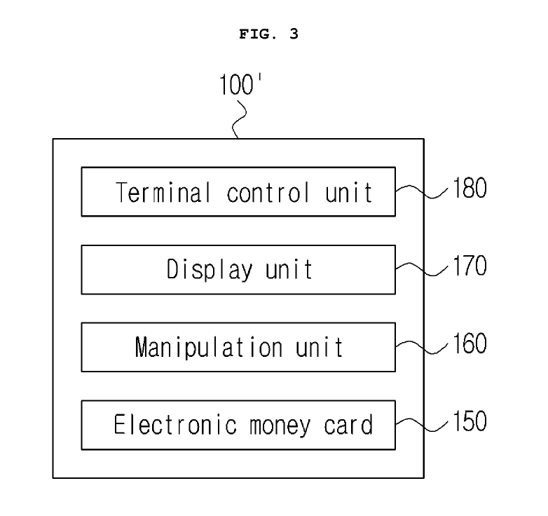

Now, the inventive terminal 100 will be described in more detail with reference to FIGS. 2 and 3.

Firstly, the inventive terminal 100 configured as a payment device located at a specific store will be described with reference to FIG. 2.

The inventive terminal 100 includes a manipulation unit 120 for receiving a user's input, and a terminal control unit 140 for sending a request for payment amount information of each currency in accordance with a payment request amount in accordance with an electronic money payment request to an external electronic money service center 200 when the electronic money payment request is input through the manipulation unit 120, for showing the payment currency information of each currency received thereby from the electronic money service center 200 to be capable of being recognized by the user, and for sending a request for processing payment in accordance with the payment amount of the predetermined currency selected from the payment amount information of each currency through the manipulation unit 120 to the electronic money service center 200.

The terminal 100 may include a card interface unit 110 for communicating with an approaching electronic money card 15, and a display unit 130.

The manipulation unit 120 is an input device for receiving a user's input from the outside, wherein the manipulation unit 120 may employ any of various types of input devices, such as a key input unit, a touch input unit, and a voice command input unit.

The card interface unit 110 is a functional unit for recognizing and communicating with the electronic money card 15 approaching to the card interface unit 110, wherein the card interface unit 110 may employ any of various types of interface functions, such as a wireless interface function for recognizing/communicating with an approaching electronic money card, a contact interface function for recognizing/communicating with an electronic money card 15 inserted into the card interface unit 110, or the like.

If an approaching or contacted electronic money card 15 is recognized through the card interface unit 110, and an electronic money payment request is input through the manipulation unit 120, the terminal control unit 140 sends a request for payment amount information of each currency in accordance with the payment request amount according to the electronic money payment request to the external electronic money service center 200.

That is, if the user 10 operates the manipulation unit 120 to input an electronic money payment request of the electronic money card 15 for a payment request amount (e.g. B KR won) desired to be paid, the terminal control unit 140 accesses the electronic money service center 200 through the network 1, and sends a request for payment amount information of each currency in accordance with the payment request amount (e.g., B KR won) according to the input electronic money payment request to the electronic money service center 200.

Consequently, when receiving the payment amount information of each currency according to the payment request amount in response to the request of the terminal control unit 140 from the electronic money service center 200, the terminal control unit 140 shows the received payment amount information of each currency to be capable of being recognized by the user 10.

That is, when receiving the payment amount information of each currency (for example, KR won, US dollars, JP yen or the like) corresponding to the payment request amount according to the request of the terminal control unit 140 from the electronic money service center 200, the terminal control unit 140 outputs the payment amount information of each currency received from the electronic money service center 200 through the display unit 130 to be capable of being visually and/or aurally recognized by the user 10.

For example, in a state in which it is recognized that an electronic money balance, A won, remains in the electronic money card 15 at the time of recognizing the electronic money card 15, if the payment amount information of each currency (KR won: B won, US dollars: C won+a commission for exchanging money, and JP yen: D won+a commission for exchanging money) corresponding to a payment request amount (e.g., B won) from the electronic money service center 200 is received in response to an electronic money payment request according to the payment request amount corresponding to B won, the terminal control unit 140 can show the payment amount information of each currency to the user 10 as follows:

Selection 1: Electronic money balance when paid in won: current balance, A won−B won

Selection 2: Balance when paid by exchanging US dollars into won: current balance, A won−(C won+a commission for exchanging money)

Selection 3: Balance when paid by exchanging JP yen into won: current balance, A won−(D won+a commission for exchanging money)

As a result, if a desired payment amount item is selected from the payment amount information of each currency shown to be capable of being recognized by the user 10 through the manipulation unit 120, the terminal control unit 140 requests the electronic money service center 200 to process payment for the electronic money card 15 in accordance with the payment amount of the selected predetermined currency.

That is, if a desired payment amount item (for example, Selection 2) is selected from the payment amount information of each currency shown as described above (for example, Selection 1, Selection 2 and Selection 3), the terminal control unit 140 can send a request for processing payment according to the payment amount in the predetermined currency (for example, US dollars) selected for the electronic money card 15 to the electronic money service center 200.

In addition, when receiving an electronic money deduction signal from the electronic money service center 200 in response to the request for processing payment, the terminal control unit 140 can balance the electronic money of the electronic money card 15 in accordance with the electronic money deduction signal.

Now, a terminal 100′ configured as a mobile device incorporating an electronic money card therein will be described with reference to FIG. 3.

The inventive terminal 100′ includes: a manipulation unit 160 for receiving a user's input; and a terminal control unit 180 for sending a request for payment amount information of each currency in accordance with a payment request amount according to an electronic money payment request to an external electronic money service center 200 when the electronic money payment request is input through the manipulation unit 160, for showing the payment currency information of each currency received thereby from the electronic money service center 200 to be capable of being recognized by the user, and for sending a request for processing payment in accordance with the payment amount of the predetermined currency selected from the payment amount information of each currency through the manipulation unit 160 to the electronic money service center 200.

The terminal 100′ may include an electronic money card 150 incorporated in the terminal, and a display unit 170.

The manipulation unit 160 is an input device for receiving a user's input from the outside, wherein the manipulation unit 160 may employ any of various types of input devices, such as a key input unit, a touch input unit, and a voice command input unit.

The electronic money card 150 incorporated in the terminal 100′ may be a user identification card of a smart card type, such as a SIM (Subscriber Identification Module) card or a USIM (Universal Subscriber Identification Module) card.

If an electronic money payment request is input through the manipulation unit 160, the terminal control unit 180 sends a request for payment amount information of each currency in accordance with the payment request amount in accordance with the electronic money payment request to the external electronic money service center 200.

That is, if the user 10 operates the manipulation unit 160 to input an electronic money payment request of the electronic money card 150 for a payment request amount (e.g. B KR won) desired to be paid, the terminal control unit 180 accesses the electronic money service center 200 through the network 1, and sends a request for payment amount information of each currency in accordance with the payment request amount (e.g., B KR won) in accordance with the input electronic money payment request to the electronic money service center 200.

Consequently, when receiving the payment amount information of each currency according to the payment request amount in response to the request of the terminal control unit 180 from the electronic money service center 200, the terminal control unit 180 shows the received payment amount information of each currency to be capable of being recognized by the user 10.

That is, when receiving the payment amount information of each currency (for example, KR won, US dollars, JP yen or the like) corresponding to the payment request amount in response to the request of the terminal control unit 180 from the electronic money service center 200, the terminal control unit 180 outputs the payment amount information of each currency received from the electronic money service center 200 through the display unit 170 to be visually and/or aurally recognizable by the user 10.

For example, in a state in which it is recognized that an electronic money balance, A won, remains in the electronic money card 150 at the time of recognizing the electronic money card 150, if the payment amount information of each currency (KR won: B won, US dollars: C won+a commission for exchanging money, and JP yen: D won+a commission for exchanging money) corresponding to a payment request amount (e.g., B won) from the electronic money service center 200 is received in response to an electronic money payment request according to the payment request amount corresponding to B won, the terminal control unit 140 can show the payment amount information of each currency to the user 10 as follows:

Selection 1: Electronic money balance when paid in won: current balance, A won−B won

Selection 2: Balance when paid by exchanging US dollars into won: current balance, A won−(C won+a commission for exchanging money)

Selection 3: Balance when paid by exchanging JP yen into won: current balance, A won−(D won+a commission for exchanging money)

As a result, if a desired payment amount item is selected from the payment amount information of each currency shown to be capable of being recognized by the user 10 through the manipulation unit 160, the terminal control unit 180 requests the electronic money service center 200 to process payment for the electronic money card 150 in accordance with the payment amount of the selected predetermined currency.

That is, if a desired payment amount item (for example, Selection 2) is selected from the payment amount information of each currency shown as described above (for example, Selection 1, Selection 2 and Selection 3), the terminal control unit 180 can send a request for processing payment according to the payment amount in the predetermined currency (for example, US dollars) selected for the electronic money card 150 to the electronic money service center 200.

In addition, when receiving an electronic money deduction signal from the electronic money service center 200 in response to the request for processing payment, the terminal control unit 180 can balance the electronic money of the electronic money card 150 in accordance with the electronic money deduction signal.

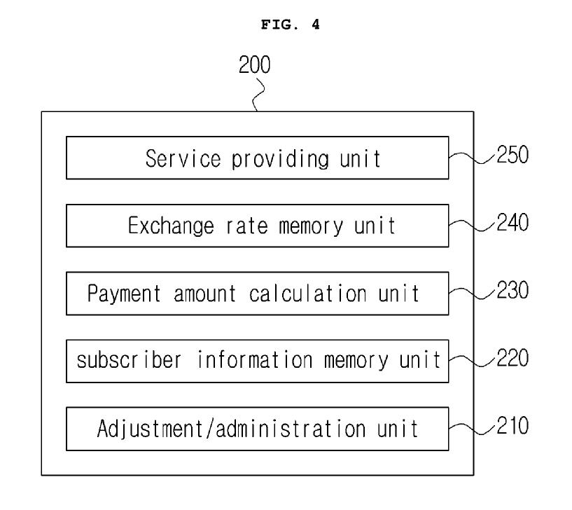

Now, the inventive electronic money service center 200 will be described in more detail with reference to FIG. 4.

As shown in FIG. 4, the inventive electronic money service center 200 includes: an exchange rate memory unit 240 for storing exchange rate information of each currency; a payment amount calculation unit 230 for conducting foreign exchange in accordance with a payment request amount based on the exchange rate information of each currency, and for calculating an amount of each currency to be paid; and a service providing unit 250 for sending a request for payment amount information of each currency, which is obtained through exchanging of the payment request amount, to the payment amount calculation unit 230, and for providing the terminal 100 or 100′ with the payment amount information of each currency calculated by the payment amount calculation unit 230 when a request for payment amount information of each currency according to the payment request amount is received from the external terminal 100 or 100′ (hereinafter, indicated by reference numeral 100).

In addition, the electronic money service center 200 may further include a subscriber information memory unit 220 for storing subscriber information for individual subscribers who have subscribed to the electronic money service, and an adjustment/administration unit 210 for administrating electronic money accounts which correspond to subscribers, respectively.

The subscriber information memory unit 220 stores subscriber information for at least one subscriber who has subscribed to the electronic money service provided by the electronic money service center 200. Here, the subscriber information may include at least one of identification information (for example, name or unique information given at the time of subscribing to the service), password information, electronic money account information, electronic money card information (for example, card identification information), terminal telephone number, e-mail address information, and banking account information of the subscriber.

The adjustment/administration unit 210 administrates electronic money accounts of individual subscribers who have subscribed to the electronic money service provided by the electronic money service center 200. That is, the adjustment/administration unit 210 can administrate electronic money balance information corresponding to each of the subscribers, and increase or deduct the electronic money balance of a corresponding electronic money account under the control of the service providing unit 250.

The exchange rate memory unit 240 is a storage unit for storing exchange rate information of each currency, wherein it is desirable that the continuous administration and update of the exchange rate information of each currency stored in the exchange rate memory unit 240 are conducted in real time.

The payment amount calculation unit 230 is a calculation unit for conducting foreign exchange, and calculating payment amounts by currencies.

That is, the payment amount calculation unit 230 can exchange a payment request amount (e.g., B won) of a predetermined currency into another currency on the basis of the exchange rate information of each currency stored in the exchange rate information memory unit 240 to calculate the exchange amounts (e.g., KR won: B won, US dollars: C won, JP yen: D won), and can calculate the payment amounts by currencies by summing commissions for exchanging money and the exchange amounts by currencies (for example, KR won: B won, US dollars: C won+the a commission for exchanging money, JP yen: D won+the a commission for exchanging money), respectively.

When receiving a request for payment amount information corresponding to a payment request amount from a terminal 100, the service providing unit 250 sends a request for payment amount information of each currency, which is obtained through exchanging of the payment request amount, to the payment amount calculation unit 230.

Specifically, when receiving a request for payment amount information corresponding to B won from the terminal 100, the service providing unit 250 sends a request for payment amount information of each currency, which is obtained through exchanging of B won, to the payment amount calculation unit 230.

Then, the service providing unit 250 provides the terminal 100 with the payment amount information of each currency (e.g., KR won: B won, US dollars: C won+a commission for exchanging money, and JP yen: D won+a commission for exchanging money) exchanged/calculated by the payment amount calculation unit 230 in accordance with the payment request amount (e.g., B won). As such, the terminal 100 can show the payment amount information of each currency (e.g., KR won: B won, US dollars: C won+a commission for exchanging money, and JP yen: D won+a commission for exchanging money) to the user 10.

In addition, when receiving a request for processing payment of an electronic money card for the payment amount of a predetermined currency among the payment amount information of each currency from the terminal 100 after the payment amount information of each currency is provided to the terminal 100, the service providing unit 250 processes payment in accordance with the payment amount of the predetermined currency if it is possible to process payment of the electronic money card.

That is, if a request for processing payment corresponding to a payment amount (C won+a commission for exchanging money) of a predetermined currency (e.g., US dollars) is received as a payment amount information item of a predetermined currency (for example, Selection 2) is selected in the terminal 100 among the payment amount information of each currency, the service providing unit 250 determines whether it is possible to process payment of the payment-requested electronic money card (for example, the electronic money card 15) or not.

For example, the service providing unit 250 can search an electronic money account corresponding to the electronic money card 15 in the adjustment/administration unit 210 to determine whether the balance of the account exceeds the payment-requested payment amount (C won+a commission for exchanging money) or not. Alternatively, if an electronic money account corresponding to the electronic money card 15 is not administrated by the adjustment/administration unit 210, the service providing unit 250 may acquire the balance information of the electronic money card 15 through the terminal 100 to determine whether it is possible to process payment or not by determining whether the balance of the account exceeds the payment-requested payment amount (C won+a commission for exchanging money) or not.

If it is determined that it is possible to process payment of the payment-requested electronic money card (for example, the electronic money card 15), the service providing unit 250 processes payment in accordance with the payment amount of the predetermined currency.

That is, the service providing unit 250 can process payment by deducting electronic money corresponding to the payment amount (C won+a commission for exchanging money) from the account of the electronic money card 15 in accordance with the payment amount (C won+a commission for exchanging money) of the corresponding payment-requested currency (for example, US dollars), and send real money corresponding to the payment amount (C won+a commission for exchanging money) to a bank account of a corresponding payment receiver.

In addition, if payment is processed in accordance with the payment amount of the predetermined currency, the service providing unit 250 provides the terminal 100 with an electronic money deduction signal according to the payment amount of the predetermined currency.

That is, the service providing unit 250 provides the terminal 100 with an electronic money deduction signal according to the payment amount (C won+a commission for exchanging money) of the corresponding payment-processed currency, so that the terminal 100 can deduct the electronic money of the electronic money card 15.

Of course, if the electronic money is not a type stored in an electronic money card 15 but a type administrated in an electronic money account corresponding to the electronic money card 15, the service providing unit 250 may send a process completion message according to the payment amount of the corresponding payment-processed currency to the terminal 100 so as to show the message to the user 10 when payment is processed in accordance with the payment amount of the predetermined currency.

As described above, if a user makes a request for electronic money payment for a payment request amount through a terminal 100, the inventive electronic money payment system allows the user 10 to select a payment amount according to a monetarily advantageous currency by showing payment amount information of each currency corresponding to a payment request amount on the terminal 100 through the cooperation between the terminal 100 and the electronic money service center 200, so that payment can be processed with the predetermined currency selected by the user.

Accordingly, when a request for processing payment using electronic money is made, the inventive electronic money payment system can process payment with a payment amount according to a currency advantageous for payment among payment amounts according to various types of currencies which are different from the type of the currency of the electronic money owned by the user, considering not only the type of the currency of the electronic money owned by the user but also the exchange rates, whereby the user can pay the payment amount, to which another type of a currency different from that of the currency of the user's electronic money is applied, using the currency of the user's electronic money.

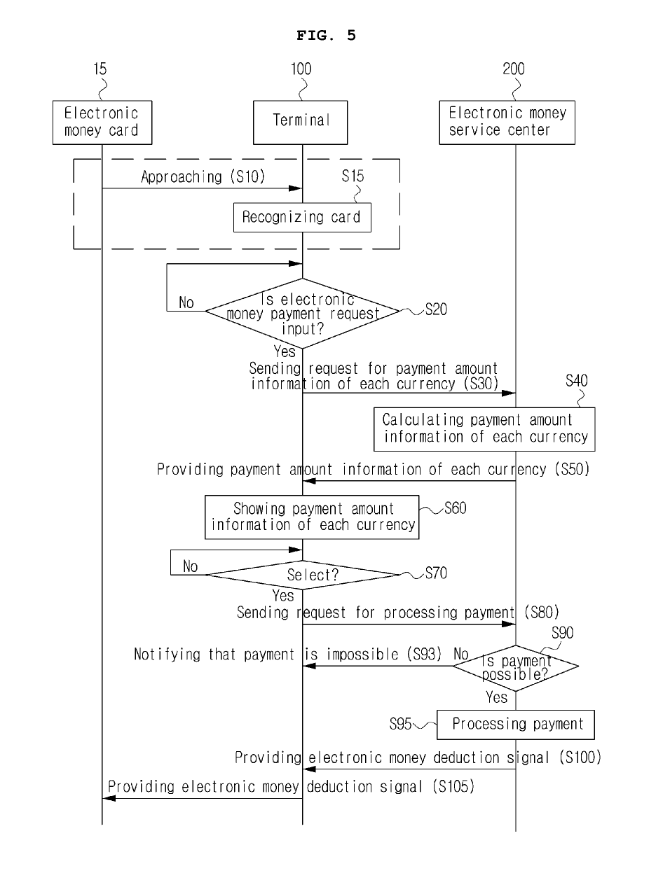

Hereinbelow, a control flow of the inventive electronic money payment method configured as described above will be described with reference to FIGS. 5 to 7. For the convenience of description, the components shown in FIGS. 1 to 4 will be described with the same reference numerals.

Firstly, the entire control flow of the inventive electronic money payment method will be described with reference to FIG. 5.

Here, the terminal 100 is a payment device located at a specific store, such as a duty-free shop or a bookstore, wherein if the terminal is configured to recognize an electronic money card presented by a user 10 who makes a request for processing payment using electronic money, the user 10 will bring an electronic money card 15 possessed by the user 10 adjacent to the terminal 100 (S10). As such, the terminal 100 recognizes the electronic money card brought adjacent to the terminal 100 (S15), and determines whether the user inputs a request for electronic money payment for a payment request amount or not (S20).

Meanwhile, if the terminal 100′ is a mobile device, such as a notebook computer, a PDA, or a mobile communication terminal, that takes a form incorporating an electronic money card 150 therein, the terminal 100′ will determine whether the user inputs a request for electronic money payment for a payment request amount or not (S20) without conducting steps S10 and S15.

If it is determined that a request for electronic money payment for a payment request amount is input by the user, the terminal 100 sends a request for payment amount information of each currency in accordance with the payment request amount according to the input request for electronic money payment to an electronic money service center 200 (S30).

After receiving the request for payment amount information of each currency in accordance with the payment request amount from the terminal 100, the electronic money service center 200 calculates payment amount information of each currency, which is obtained through exchanging of the payment request amount based on exchange rate information of each currency (S40), and provides the terminal 100 with the calculated payment amount information of each currency (S50).

After receiving the payment amount information of each currency from the electronic money service center 200 in response to the request for payment amount information of each currency in accordance with the payment amount sent to the electronic money service center 200 in step S30, the terminal 100 shows the payment amount information of each currency received from the electronic money service center 200 in such a manner that the user 10 can recognize the payment amount information of each currency (S60).

In addition, the terminal 100 determines whether a payment amount information item is selected from the payment amount information of each currency shown by the terminal 100 (S70), and if a payment amount information item is selected, the terminal 100 sends a request for processing payment for the electronic money card 15 in accordance with the payment amount of the selected currency to the electronic money service center 200 (S80).

In addition, when receiving the request for processing payment for the payment amount of the predetermined currency from the terminal 100, the electronic money service center 200 determines whether it is possible to process payment in accordance with the payment amount of the corresponding amount with the electronic money card 15 (S90), and if it is determined that if it is possible to process payment, the electronic money service center 200 processes payment for the electronic money card 15 in accordance with the payment amount of the predetermined currency (S95). However, if it is determined that it is impossible to process payment in step S90, the electronic money service center 200 can notify the terminal 100 in step S90 that payment is impossible (S93).

In addition, the electronic money service center 200 provides the terminal 100 with an electronic money deduction signal according to the payment amount of the payment-processed currency (S100), so that the terminal 100 can deduct the electronic money of the electronic money card 15 (S105).

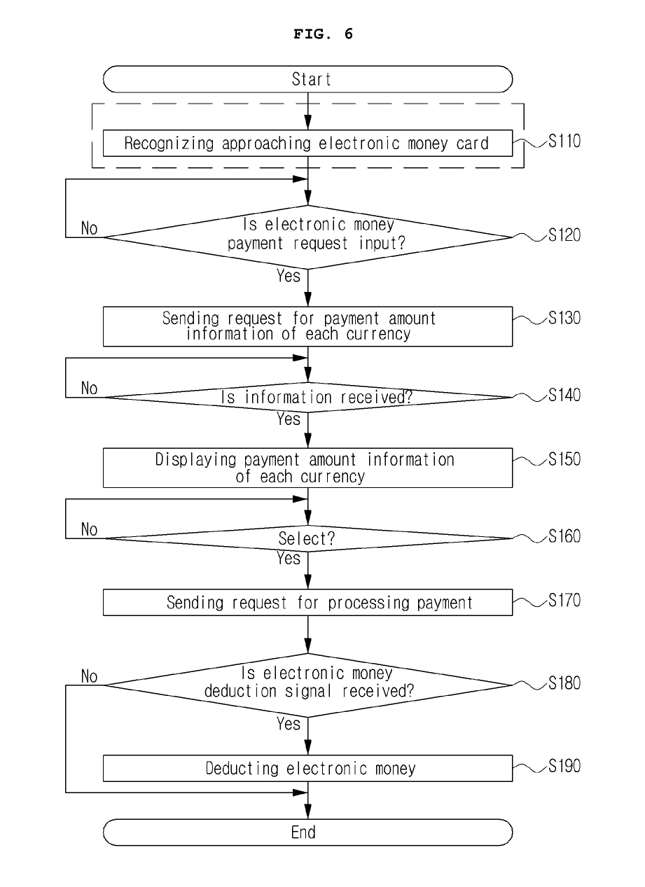

Now, the inventive payment method by a terminal 100 will be described in more detail with reference to FIG. 6.

The inventive payment method by terminal 100 recognizes an electronic money card brought adjacent to the terminal 100 or brought into contact with the terminal 100 (S110). That is, the terminal 100 can recognize an electronic money card 15 which is brought adjacent to the terminal 100 or brought into contact with the terminal 100 by the user 10 who wishes to make a request for electronic money payment.

In addition, the inventive payment method by the terminal 100 determines whether an electronic money payment request corresponding to a payment request amount is input or not (S120). That is, if the user 10 operates the manipulation unit 120 to input an electronic money payment request of an electronic money card for the payment request amount (e.g., B won) that the user 10 wishes to pay, the terminal 100 can consider it as an electronic money payment request is input.

Therefore, if an electronic money payment request is input, the inventive payment method by the terminal 100 sends a request for payment amount information of each currency to an external electronic money service center 200 in accordance with the payment request amount according to the electronic money payment request (S130).

That is, if the user 10 operates the manipulation unit 120 to input an electronic money payment request of the electronic money card 15 for the payment request amount (e.g., B won) that the user 10 wishes to pay, the terminal 100 accesses the electronic money service center 200 through the network 1, and sends a request for payment amount information of each currency in accordance with the payment request amount (e.g., B won) according to the input electronic money payment request to the electronic money service center 200.

Then, the terminal 100 determines whether the payment amount information of each currency corresponding to the payment request amount according to the request is received from the electronic money service center 200 (S140), and when receiving the payment amount information of each currency, the terminal 100 shows the received payment amount information of each currency to be capable of being recognized by the user 10 (S150).

That is, when receiving the payment amount information of each currency (for example, KR won, US dollars, JP yen, etc.) according to the payment request amount in response to the request of the terminal 100 from the electronic money service center 200, the terminal 100 outputs the payment amount information of each currency received from the electronic money service center 200 through the display unit in such a manner that the user can visually and/or aurally recognize the payment amount information of each currency.

For example, in a state in which it is recognized that an electronic money balance, A won, remains in the electronic money card 15 at the time of recognizing the electronic money card 15, if the payment amount information of each currency (KR won: B won, US dollars: C won+a commission for exchanging money, and JP yen: D won+a commission for exchanging money) corresponding to a payment request amount (e.g., B won) from the electronic money service center 200 is received in response to an electronic money payment request according to the payment request amount corresponding to B won, the terminal control unit 140 can show the payment amount information of each currency to the user 10 as follows:

Selection 1: Electronic money balance when paid in won: current balance, A won−B won

Selection 2: Balance when paid by exchanging US dollars into won: current balance, A won−(C won+a commission for exchanging money)

Selection 3: Balance when paid by exchanging JP yen into won: current balance, A won−(D won+a commission for exchanging money)

In addition, the terminal 100 determines whether any payment amount information item is selected from the shown payment amount information of each currency or not (S160). That is, the terminal 100 determines whether a payment amount information item is selected through the manipulation unit 120 among the payment amount information of each currency shown to be capable of being recognized by the user 10 or not (S160), and sends a request processing payment for the electronic money card 15 in accordance with the payment amount of the selected currency to the electronic money service center 200 (S170).

That is, if a payment amount information item (for example Selection 2) is selected from the payment amount information of each currency (for example, Selection 1, Selection 2 and Selection 3) shown as described above, the terminal 100 can send a request for processing payment according to the payment amount (C won+a commission for exchanging money) of the predetermined currency (for example, US dollars) selected for the electronic money card 15 to the electronic money service center 200.

In addition, the terminal 100 determines whether an electronic money deduction signal is received from the electronic money service center 200 as the request for processing payment is made (S180), and if the electronic money deduction signal is received, the terminal 100 can deduct the electronic money of the electronic money card 15 in accordance with the electronic money deduction signal (S190).

As described above with reference to FIG. 3, the terminal 100′ configured as a mobile device incorporating an electronic card 150 does not conduct step S110, and the terminal 100′ requests the electronic money service center 200 to process payment for the electronic money card 150 in accordance with the payment amount of the predetermined currency selected in step S170, and deducts the electronic money of the electronic money card 150 in accordance with the electronic money deduction signal received in step S190.

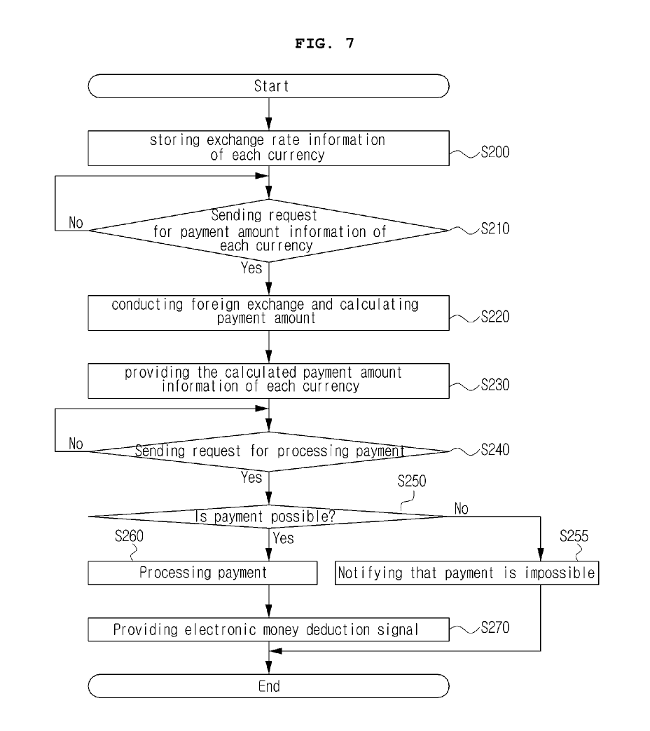

Now, the inventive payment method by an electronic money service center 200 will be described with reference to FIG. 7.

In accordance with the inventive payment method by the electronic money service center 200, exchange rate information is stored by currencies (S200). It is desirable that such exchange rate information of each currency is continuously administrated and updated in real time.

In addition, in accordance with the inventive payment method by the electronic money service center 200, it is determined whether a request for payment amount information of each currency corresponding to a payment request amount from a terminal 100 is received or not (S210). That is, the electronic money service center 200 determines whether a request for payment amount information of each currency corresponding to a payment request amount (e.g., B won) is received from the terminal 100 which accesses the electronic money service center 200. That is, the electronic money service center 200 determines whether a request for payment amount information of each currency corresponding to a payment request amount (e.g., B won) is received from the terminal 100 which accesses the electronic money service center 200 through the network 1.

When receiving the request for payment amount information of each currency corresponding to the payment request amount, the electronic money service center 200 of the inventive payment method calculates the payment amount information of each currency, which is obtained through exchanging of the payment request amount (S220).

That is, the electronic money service center 200 can exchange a payment request amount (e.g., B won) of a predetermined currency into another currency on the basis of the previously stored exchange rate information of each currency to calculate the exchange amount (e.g., KR won: B won, US dollars: C won, JP yen: D won), and can calculate the payment amounts by currencies by summing commissions for exchanging money and the exchange amounts by currencies (for example, KR won: B won, US dollars: C won+the a commission for exchanging money, JP yen: D won+the a commission for exchanging money), respectively.

Consequently, the electronic money service center 200 of the inventive payment method provides the terminal 100 with the payment amount information of each currency (e.g., KR won: B won, US dollars: C won+a commission for exchanging money, and JP yen: D won+a commission for exchanging money) exchanged/calculated in accordance with the payment request amount (e.g., B won) (S230). As such, the terminal 100 can show the payment amount information of each currency (e.g., KR won: B won, US dollars: C won+a commission for exchanging money, and JP yen: D won+a commission for exchanging money) to the user 10

In addition, after the payment amount information of each currency is provided to the terminal 100, the electronic money service center 200 of the inventive payment method determines whether a request for processing payment of an electronic money card (for example, the electronic money card 15) for the payment amount of a predetermined currency among the payment amount information of each currency is received from the terminal 100 (S240), and if the request for processing payment is received, the inventive payment method by the electronic money service center 200 processes payment in accordance with the payment amount of the predetermined currency if it is possible to process payment of the electronic money card 15.

That is, if a request for processing payment according to a payment amount (C won+a commission for exchanging money) of a predetermined currency (e.g., US dollars) is received as a result of selecting a payment amount information item of a predetermined currency (for example, Selection 2) in the terminal 100 among the payment amount information of each currency, the electronic money service center 200 determines whether it is possible to process payment of the payment-requested electronic money card (for example, the electronic money card 15) or not (S250).

For example, the electronic money service center 200 can search an electronic money account corresponding to the electronic money card 15 in the adjustment/administration unit 210 to determine whether the balance of the account exceeds the payment amount requested to process payment (C won+a commission for exchanging money) or not. Alternatively, if an electronic money account corresponding to the electronic money card 15 is not administrated by the adjustment/administration unit 210, the electronic money service center 200 may acquire the balance information of the electronic money card 15 through the terminal 100 to determine whether the balance of the account exceeds the payment-requested payment amount (C won+a commission for exchanging money) or not, thereby determining whether it is possible to process payment or not.

If it is possible to process payment of the electronic money card as requested (for example, the electronic money card 15), the inventive payment method by the electronic money service center 200 processes payment in accordance with the payment amount of the predetermined currency (S260). That is, the electronic money service center 200 can process payment by deducting electronic money corresponding to the payment amount (C won+a commission for exchanging money) from the account of the electronic money card 15 in accordance with the payment amount (C won+a commission for exchanging money) of the corresponding payment-requested currency (for example, US dollars), and sending real money according to the payment amount (C won+a commission for exchanging money) to a bank account of a corresponding payment receiver.

If it is determined that it is impossible to process payment of the electronic money card 15 as the result of determination in step S250, the inventive payment method by the electronic money service center 200 can notify the terminal 100 that it is impossible to process payment (S255).

In addition, if payment is processed in accordance with the payment amount of the predetermined currency in step 260, the inventive payment method by the electronic money service center 200 provides the terminal 100 with an electronic money deduction signal according to the payment-processed payment amount of the predetermined currency (S270).

That is, the electronic money service center 200 provides the terminal 100 with an electronic money deduction signal according to the payment-processed payment amount of the predetermined currency, so that the terminal 100 can deduct the electronic money of the electronic money card 15.

Of course, if the electronic money card is a type of being administrated in an electronic money account corresponding to the electronic money card 15 rather than being stored, the electronic money service center may send a process completion message according to the payment-processed payment amount of the predetermined currency to the terminal 100 so as to show the message to the user 10 when payment is processed in accordance with the payment amount of the predetermined currency.

As described above, if a user makes a request for electronic money payment for a payment request amount through a terminal 100, the inventive electronic money payment method allows the user 10 to select a payment amount according to a monetarily advantageous currency by showing payment amount information of each currency corresponding to the payment request amount on the terminal 100 through the cooperation between the terminal 100 and the electronic money service center 200, so that payment can be processed with the predetermined currency selected by the user.

Accordingly, when a request for processing payment using electronic money is made, it is possible to process payment not only with a payment amount according to the currency of the user's electronic money but also with a payment amount according to any currency advantageous for payment among various payment amounts according to various types of currencies which are different from that of the user's electronic money, in consideration of the exchange rates, whereby the user can process payment with a payment amount of a currency, which is different from that of the user's electronic money, using the user's electronic money. As a result, the user can obtain monetary profit according to current exchange rates.

Although several exemplary embodiments of the present invention have been described for illustrative purposes, those skilled in the art will appreciate that various modifications, additions and substitutions are possible, without departing from the scope and spirit of the invention as disclosed in the accompanying claims.

1. An electronic money payment system comprising:
a terminal for sending a request for payment amount information of each currency in accordance with a payment request amount according to an electronic money payment request when the electronic money payment request is input to the terminal; and
an electronic money service center for providing the terminal with the payment amount information of each currency, which is obtained through exchanging of the payment request amount based on exchange rate information of each currency, when receiving the request for the payment amount information of each currency, and processing payment of a payment amount of a predetermined currency when receiving a request for processing payment for the payment amount of the predetermined currency from the terminal.

2. The electronic money payment system as claimed in claim 1, wherein, when receiving the payment amount information of each currency from the electronic money service center, the terminal displays the payment amount information of each currency and sends a request for processing payment in accordance with the payment amount of a predetermined currency selected from the payment amount information of each currency to the electronic money payment system.

3. A terminal comprising:
a manipulation unit for receiving a user's input; and
a terminal control unit for sending a request for payment amount information of each currency to an external electronic money service center in accordance with a payment request amount according to an electronic money payment request when the electronic money payment request is input through the manipulation unit, displaying the payment amount information of each currency received from the electronic money service center in response to the request for payment amount information of each currency, and sending a request for processing payment in accordance with a payment amount of a predetermined currency selected from the payment amount information of each currency through the manipulation unit to the electronic money payment system.

4. The terminal as claimed in claim 3, further comprising a card interface unit for communicating with an approaching electronic money card, wherein the terminal control unit recognizes the approaching electronic money card through the card interface unit, and when an electronic money payment request is input through the manipulation unit, the terminal control unit sends a request for payment amount information of each currency in accordance with a payment request amount according to the electronic money payment request to the electronic money service center.

5. The terminal as claimed in claim 4, wherein the terminal control unit sends a request for processing payment for the electronic money card in accordance with the payment amount of the currency selected through the manipulation unit to the electronic money service center, and when receiving an electronic money deduction signal from the electronic money service center in response to the request for processing payment for the electronic money card, the terminal control unit deducts the electronic money of the electronic money card in accordance with the electronic money deduction signal.

6. The terminal as claimed in claim 3, further comprising an electronic money card for storing electronic money, wherein the terminal control unit sends a request for processing payment for the electronic money card in accordance with the payment amount of the currency selected through the manipulation unit to the electronic money service center, and when receiving an electronic money deduction signal from the electronic money service center in response to the request for processing payment for the electronic money card, the terminal control unit deducts the electronic money of the electronic money card in accordance with the electronic money deduction signal.

7. An electronic money service center comprising:
an exchange rate memory unit for storing exchange rate information of each currency;
a payment amount calculation unit for conducting foreign exchange in accordance with a payment request amount, and calculating a payment amount of each currency based on the exchange rate information of each currency; and
a service providing unit for, when receiving a request for payment amount information of each currency according to a payment request amount from an external terminal, sending the request for payment amount information of each currency, which is obtained through exchanging of the payment request amount, to the payment amount calculation unit and providing the terminal with the payment amount information of each currency calculated by the payment amount calculation unit.

8. The electronic money service center as claimed in claim 7, wherein when receiving a request for processing payment of an electronic money card for the payment amount of the predetermined currency selected from the payment amount information of each currency from the terminal after the electronic money service center provides the terminal with the payment amount information of each currency, the service providing unit processes payment in accordance with the payment amount of the predetermined currency if the payment of the electronic money card is possible.

9. The electronic money service center as claimed in claim 8, wherein when processing payment in accordance with the payment amount of the predetermined currency, the service providing unit provides the terminal with an electronic money deduction signal according to the payment amount of the predetermined currency as being payment-processed.

10. An electronic money payment method comprising the steps of:
sending, by a terminal, a request for payment amount information of each currency in accordance with a payment request amount according to an electronic money payment request that is input to the terminal;
providing, by an electronic money service center, the terminal with payment amount information of each currency, which obtained through exchanging of the payment request amount based on exchange rate information of each currency, when the request for payment amount information of each currency is received from the terminal in accordance with the payment request amount; and
processing payment, by the electronic money service center, in accordance with the payment amount of a predetermined currency when a request for processing payment for the payment amount of a predetermined currency among the payment amount information of each currency is received from the terminal.

11. The electronic money payment method as claimed in claim 10, further comprising the steps of:
displaying, by the terminal, the payment amount information of each currency when the payment amount information of each currency is received from the electronic money service center; and
sending, by the terminal, a request for processing payment in accordance with the payment amount of the predetermined currency selected from the payment amount information of each currency to the electronic money service center.

12. A payment method by a terminal comprising the steps of:
determining whether an electronic money payment request is input or not;
sending a request for payment amount information of each currency in accordance with a payment request amount according to the electronic money payment request to an external electronic money service center if the electronic money payment request is input;
displaying the payment amount information of each currency received from the electronic money service center; and
sending a request for processing payment in accordance with the payment amount of a predetermined currency selected from the payment amount information of each currency to the electronic money service center.

13. The payment method as claimed in claim 12, wherein the step of determining whether the electronic money payment request is input or not comprises the steps of:
recognizing an approaching electronic card; and
determining whether the electronic money payment request is input in accordance with the recognized electronic money card.

14. The payment method as claimed in claim 13, further comprising the step of:
deducting the electronic money of the electronic money card in accordance with an electronic money deduction signal if the electronic money deduction signal is received from the electronic money service center in response to the request sent to the electronic money service center for processing payment for the electronic money card in accordance with the payment amount of the selected currency.

15. The payment method as claimed in claim 12, further comprising the step of:
deducting the electronic money of the electronic money card in accordance with an electronic money deduction signal if the electronic money deduction signal is received from the electronic money service center in response to the request sent to the electronic money service center for processing payment for the electronic money card incorporated in the terminal in accordance with the payment amount of the selected currency.

16. A payment method by an electronic money service center comprising the steps of:
storing exchange rate information of each currency;
conducting foreign exchange based on the exchange rate information of each currency, and calculating payment amount of each currency in accordance with a payment request amount if a request for payment amount information of each currency according to the payment request amount is received from an external terminal; and
providing the terminal with the calculated payment amount information of each currency.

17. The payment method as claimed in claim 16, further comprising the steps of:
determining whether a request for processing payment of an electronic money card for the payment amount of a predetermined currency among the payment amount information of each currency is received from the terminal after the payment amount information of each currency is provided to the terminal; and
processing payment in accordance with the payment amount of the predetermined currency if the request for processing payment is received and if it is possible to process payment of the electronic money card.

18. The payment method as claimed in claim 17, further comprising the step of:
providing the terminal with an electronic money deducting signal according to the processed payment amount in the predetermined currency if payment is processed in accordance with the payment amount of the predetermined currency.
